(19) United States
(12) Patent Application Publication
(10) Pub. No.: US 2021/0220817 A1
(43) Pub. Date: Jul. 22, 2021

(54) Apparatus For Manufacturing Cell Therapy Product

(71) Applicant: Min Wei, Carmel, IN (US)

(72) Inventor: Min Wei, Carmel, IN (US)

(21) Appl. No.: 17/055,598

(22) PCT Filed: Nov. 28, 2019
(86) PCT No.: PCT/US2019/063822

§ 371 Date: Nov. 15, 2020

Related U.S. Application Data
(60) Provisional application No. 62/777,112, filed on Dec. 8, 2018.

(51) Int. Cl. B01L 3/00; B01F 15/02

(52) U.S. Cl. CPC B01L 3/5021; B01F 15/0237; B01L 2400/0475; B01L 2200/0689; B01F 15/0297

(57) ABSTRACT

A system and the method of use for processing a cell therapy product includes a centrifugation container and a rotor generating centrifugal field that extends to the centrifugation container. The centrifugation container has a substantially cylindrically shaped container body and a movable plunger rod. The container body contains cell suspension and the movable plunger rod is configured to have a mixing blade at the end of the movable plunger rod contacting the cell suspension in the container body. The mixing blade on the movable plunger rod generates mixing force applied to the cell suspension when the movable plunger rod is rotated around axis of the container body. The end of the movable plunger rod contacting the cell suspension is also movable in the container body along longitudinal direction of the container body when withdrawing and expelling fluid in and out of the centrifugation container body.

### CROSS-REFERENCE TO RELATED APPLICATIONS

This application claims the benefit of U.S. Provisional Application Ser. No. 62/777,112, filed on Dec. 8, 2018.

### TECHNICAL FIELD

The invention relates to an apparatus for cell therapy product manufacturing.

### BACKGROUND OF THE INVENTION

This invention relates generally to devices and methods for the processing of cell therapy products.

Cell therapy (also called cellular therapy or cytotherapy) is therapy in which cellular materials are injected, grafted or implanted into a patient. In recent years, the field of cell therapy has expanded rapidly. Despite being one of the fastest growing areas within life sciences, the manufacturing of cell therapy products is largely hindered by small scale batches and labor intensive processes. A number of manufacturers are turning to automated processing methods of production in closed system, eliminating human involvement and risk of contamination. The new methods of cell therapy manufacturing will open up larger scale production of higher quality cell therapy products at lower cost.

In the cell therapy product manufacturing process, there are multiple steps involving media change. For example, current methods for cryopreservation of cells involve change liquid media from cell culture media to cryopreservation media. Conventional steps for preserving living cells in the frozen state have been available for many years. In general, the steps involved in this media exchange process are as follows: (1) collecting cells after cell culture; (2) removing cell culture media by centrifugation; (3) adding cryopreservation media to the cells and re-suspending cells in the cryopreservation media prior to freezing; (4) freezing the cells for long term storage. Another example is replacing cryopreservation media with infusion media before infusing the cell therapy product to patient. In this example, the steps involved the media exchange process are as follows: (1) thaw the frozen cell therapy product; (2) removing the cryopreservation media by centrifugation; (3) adding infusion media to the cells and re-suspending cells in the infusion media prior to infusion; (4) infusing the final cell suspension to patient.

During media exchange, centrifugation is commonly used to separate cell and liquid media because centrifugation systems can be easily optimized for processing speed, separation quality, the type of sample to be separated or the amount of material to be processed. However, traditional centrifugation often involves manual manipulation. In the first example discussed previously, cells collected at the bottom of the centrifugation container form a “pellet” and the supernatant above the “pellet” is removed by manual aspiration after centrifugation. When adding cryopreservation media and re-suspending cells in cryopreservation media, manual agitation is often required to break up the cell “pellet” and ensure that cells are homogeneously suspended in cryopreservation media without aggregates. In this case, the media exchange process uses multiple manual steps with open manipulations, which can cause manufacturing inconsistency and bacteria contamination.

Currently, there are some apparatus available for the automatic media exchange process in closed system, for example, Fresenius Kabi LOVO and GE Sepax systems. However, these systems have some drawbacks. In the first example discussed previously, these systems need to use large amount of cryopreservation media to replace cell culture media, which significantly increases manufacturing cost. Moreover, cells will be exposed to cryopreservation media for a long time when using the current available apparatus. Because cryopreservation media are toxic to cells and have negative impact on cell's health, long exposure time in cryopreservation media is not desired. Additionally, there will be relatively high amount of culture media residual left after the media change using the current available apparatus because the cells don't form “pellet” using the these apparatus. Lastly, these systems often use peristaltic pump to move fluids, including cell suspension. The mechanical stress generated by peristaltic pump can potentially damage cell structure and reduce cell viability.

There is therefore a need in the art for a fully automatic, easy to set up and use, closed media exchange system with low cost for manufacturing cell therapy products. Such an apparatus greatly increase the manufacturability, product quality and usefulness of cell therapy products.

### SUMMARY OF THE INVENTION

In one form thereof, the present invention includes a console or electromechanical instrument that may be used to perform several different cell therapy product processing procedures. The console is low cost, compact and may have various valves, pressure-sensing transducers, cell detectors and other devices needed to implement the process using a closed, sterile disposable set. The disposable set in this invention is specifically designed to implement a process and to contain all associated cells and fluids in a closed form. As many functions and devices as possible are placed in the console, allowing simplification and reduction in size of the disposable set.

The disposable set of the invention comprise a centrifugation container with a movable plunger rod, wherein the movable plunger rod may be configured to have one or more mixing blades at the end contacting fluid in the centrifugation container, in order to create fluid mixing during re-suspension. The movable plunger rod is operable in a first mode to move inside the centrifugation container along the longitudinal direction of the centrifugation container for moving fluid in and out of the centrifugation container. By this way, the use of peristaltic pump can be avoided and likelihood of cell damage caused by mechanical stress can be reduced. The movable plunger rod is also operable in a second mode to rotate around the axis of the centrifugation container to create mixing forces within the centrifugation chamber in order to suspend cell in fluid media. The systems and methods further include a control mechanism that is operable in a centrifugation mode and in a re-suspension mode.

In the centrifugation mode, the control mechanism operates the movable plunger rod in its first mode, moving the movable plunger rod up and down inside the centrifugation container, while (i) withdrawing fluid into the centrifugation container, and (ii) expelling fluid out of the centrifugation container. In the re-suspension mode, the control mechanism operates the movable plunger rod in its second mode, rotating the movable plunger rod inside the centrifugation container, to suspend the cells within the centrifugation container in response to the mixing force.

In a preferred embodiment, the control mechanism is further operable in a collection mode for conveying cell suspension, for example, cell suspension after cell culture, from a separation container or chamber resulted from other process step.

In a preferred embodiment, the control mechanism is further operable in a filling mode for conveying the cell re-suspension into a separation container or chamber, for example, final product container.

The invention is especially well suited for re-suspending a cell pellet during a final cell therapy product formulation process to enable cryopreservation.

In a preferred embodiment, the control mechanism is further equipped with temperature control and/or other process parameter sensors in order to improve cell viability during the process.

In a preferred embodiment, the control mechanism is further equipped with optical sensors to detect cells in the fluid path in order to reduce cell loss during the process.

In accordance with the invention, a single use, sterile, self-contained, compact, easy to use disposable centrifugation kit is provided for quick, reliable media exchange process. It therefore provides a low cost and easily assembled configuration of disposables which can be operated automatically within the apparatus. A feature of the invention is that status of the media exchange can be easily controlled and monitored in terms of the plunger rod position in the centrifugation container, and by the detection of cells in the fluid tubing. With the apparatus, the centrifugation process is sufficiently enough that 95% or more of the old media are removed from the cell therapy product and the re-suspension process step is efficient enough to break up most of the cell aggregations.

### BRIEF DESCRIPTION OF THE DRAWINGS

The figures are schematic and simplied for clarity, and they just show details, which are essential to the understanding of the invention, while other details are left out. Throughout, the same reference numerals are used for identical or corresponding parts. Some embodiments are illustrated by way of example and not limitation in the figures of the accompanying drawings in which:

FIG. 1 is a conceptual design view of a console for manufacturing cell therapy product, in accordance with the present invention;

FIG. 2 is a schematic view of a disposable set to implement a media exchange process in the console for manufacturing cell therapy products, in accordance with the present invention;

FIG. 3 is a perspective view of a centrifugation container used in the disposable set, in accordance with the present invention;

FIG. 4 is an exploded view of the centrifugation container, in accordance with the present invention;

FIG. 5 a perspective view of a plunger rod in the centrifugation container, in accordance with the present invention;

FIG. 6-10 show a series of cross-sectional views of the centrifugation container during the media exchange process, in accordance with the present invention.

FIG. 11 depicts a conceptual design and operation of the centrifugation process within the console, in accordance with the present invention.

FIG. 12 is conceptual representation of motor and shaft arrangement inside of the console, in accordance with the present invention;

FIGS. 13 and 14 depict conceptual operation of moving fluid in and out of the centrifugation container within the console, in accordance with the present invention.

FIGS. 15 and 16 depict conceptual operation of re-suspension process within the console, in accordance with the present invention;

FIG. 17 is a schematic view of an alternative design of the disposable set to implement a media exchange process in the console for manufacturing cell therapy products, in accordance with the present invention.

FIG. 18 is a schematic view of another alternative design of the disposable set to implement a media exchange process in the console for manufacturing cell therapy products, in accordance with the present invention.

### DETAILED DESCRIPTION OF THE INVENTION

The present invention will become more fully understood from the detailed description given hereinbelow and the accompanying drawings which are given by way of illustration only, and thus, are not limitive of the present invention, and wherein:

The apparatus and methods presented herein can be used for manufacturing cell therapy products. For drawings presented herein, initially it may be convenient to define that, the words “top”, “bottom”, “up”, “down”, “upper”, “lower”, “right” and “left” designate directions in the drawings to which reference is made. The words “inward” and “outward” refer to directions toward and away from, respectively. The words “interior” and “exterior” refer to locations inside and outside, respectively.

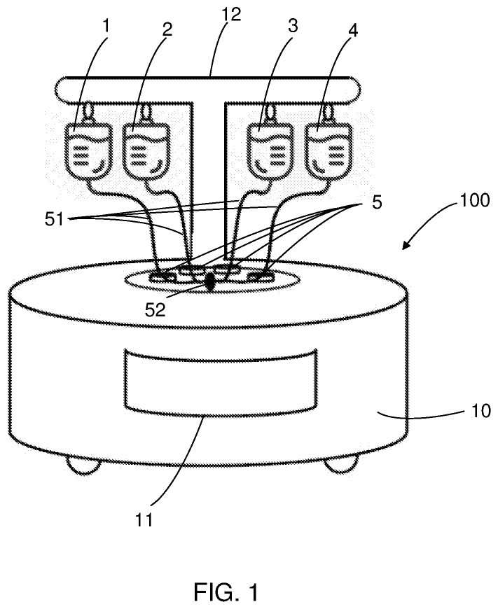

With reference to FIG. 1, the apparatus of this invention includes a console 100 that has a console housing 10 enclosing electronic, electromechanical and mechanical components. There is a display panel 11 on the front of the console housing 10 for displaying process information and providing interaction interface for operator. On the top of the console housing 10, there is a frame 12 for placing various container components 1-4. These container components may include one or more solution bags, bottles, vials or syringes, such as cell suspension bags containing cells and culture media, washing media, cryopreservation media or infusion media; cryopreservation media bag; process media solution bag; a frozen cell product bag; a recirculation bag; a satellite bag; a waste bag; or blood product bag, such as a bag of leukapheresis materials. Various combinations of these container components may be utilized, according to different embodiments of the present invention. The container components vary for each process, but can further include accessory components such as a leukofilter, bacterial filters and possible air or bubble traps.

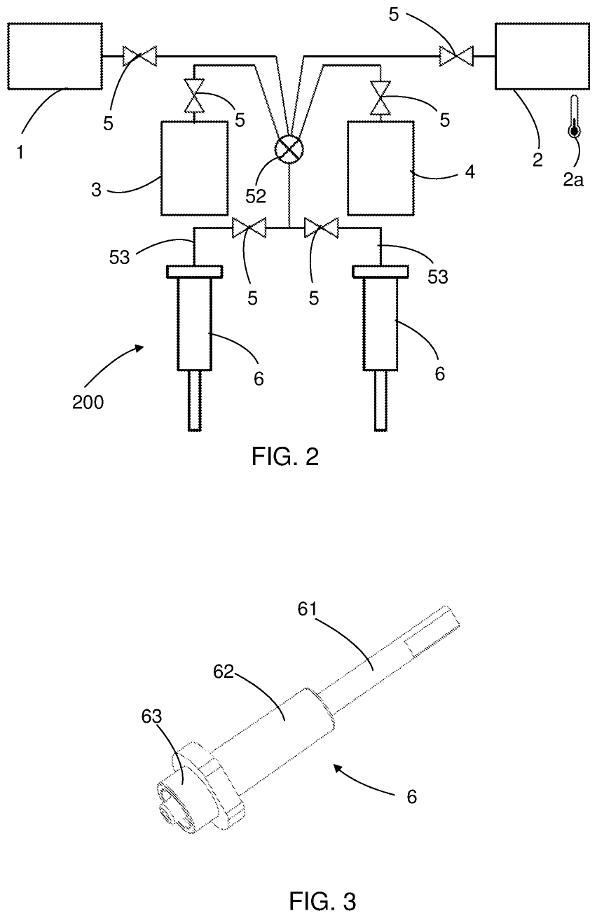

The disposable sets 200 for the processes implemented by the system have several components as well as the overall design approach in common. This overall design is conceptually depicted in FIG. 2. The disposable set 200 consists of a manifold 52, at least one centrifugation container 6 and at least two container components to store different types of fluids during the process. These container components may be attached to a manifold 52 by tubing 51. The centrifugation container 6 may be connected to the manifold 52 by tubing 53. The fluid control valves 5 are used to control the flow pathways and can be part of the disposable set or be part of the console. With reference to FIG. 2, the manifold 52 may be incorporated with several components, including fluid flow pathways and the sensor and valve actuation components; control valves 5 to turn on or off fluid flow in selected fluid pathways; and possible pressure sensors to measure fluid pressures in selected fluid pathways.

In various embodiments of the instant invention, the disposable set 200 may be used to: (1) change cell suspension media from cell culture media to cryopreservation media, (2) change cell suspension media from cryopreservation media to infusion media (3) remove plasma from leukapheresis and re-suspend white blood cells in cell culture media, as well as other media exchange process steps in cell therapy product manufacturing. The operation of the apparatus of this invention is substantially similar in each application—various cell suspensions are separated into layers by weight via centrifugation. It will thus be readily understood by those of skill in the art that the following example description of the operation of the disposable set with respect to the media exchange for preparing cell suspension for cryopreservation is substantially similar to other media exchange operations during cell therapy product manufacturing.

The media exchange for preparing cell suspension for cryopreservation will now be described. The disposable set 200 is designed to provide media exchange through a centrifugation container, meeting the various requirements for flow rate, cell concentration, viscosity, and the like. A conceptual design of the disposable set 200 is shown in FIG. 2. Container component 1 is to contain cell suspension in cell culture media. Container component 2 is to contain cell suspension in cryopreservation media. A temperature control accessory 2a can be placed adjacent to the container component 2 to keep the container component 2 and its content at low temperature, for example, 2 to 5° C. Container component 3 is to contain waste, and container component 4 is to contain fresh cryopreservation media. At beginning of the media exchange process, control valves 5 for container component 1 and for centrifugation container 6 are opened. By moving the movable plunger rod in the centrifugation container 6 (more details about design and function of the centrifugation container 6 will be explained later), cell suspension in culture media is withdrawn from the container component 1 into the centrifugation container 6. After the centrifugation container 6 is filled with cell suspension in culture media, the control valves 5 are closed. Then, centrifugation starts at sufficient speed to rapidly separate the cell suspension into cell pellet layer and culture media supernatant layer. When the centrifugation process completes, the control valves 5 for container component 3 and for centrifugation container 6 are opened. By moving the moving the movable plunger rod in the centrifugation container 6, the culture media supernatant layer is expelled out from the centrifugation container 6 into the container component 3 while leaving the cell pellet layer inside of the centrifugation container 6. Then, the control valve 5 for the container component 3 is closed and the control valve for the container component 4 is opened. By moving the moving the movable plunger rod in the centrifugation container 6, fresh cryopreservation media is withdrawn from the container component 4 into the centrifugation container 6. After the centrifugation container 6 is filled with the fresh cryopreservation media with sufficient volume in order to prepare target cell concentration for cryopreservation, the movement of the movable plunger rod in the centrifugation container is stopped and all control valves 5 are closed. Then, by rotating the movable plunger rod in the centrifugation container, mixing forces are created and the cell pellet in the centrifugation container 6 is homogenously re-suspended in the cryopreservation media. Finally, the control valves for the container component 2 and for the centrifugation container 6 are opened, the cell suspension in cryopreservation media is expelled out from the centrifugation container and filled into the container component 2, by moving the movable plunger rod.

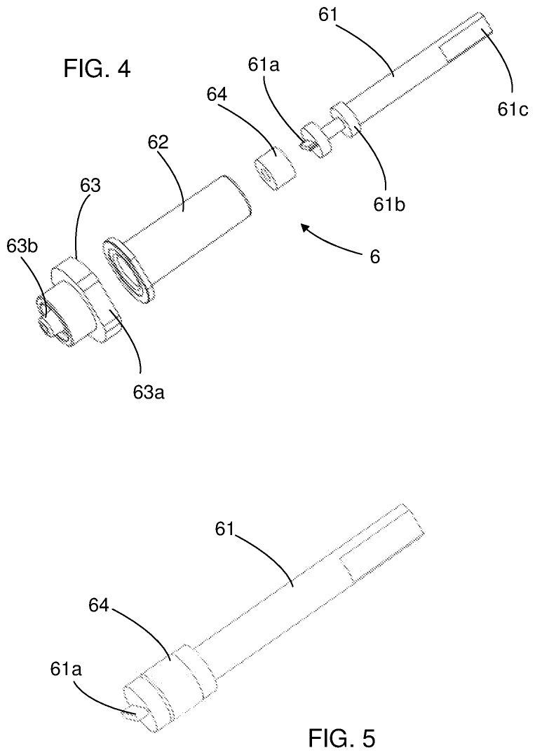

In the patent drawings, FIGS. 3 to 10 illustrate the construction and function mechanism of the centrifugation container 6. In the centrifugation container 6, a substantially cylindrically shaped container body 62 contains cell suspension fluid for processing. A movable plunger rod 61 is placed in the container body 62 and an outward shoulder design feature 61b on the movable plunger rod 61 may be landed on an inward ledge feature 62a of the container body 62. With these design features, the movable plunger rod 61 can move inside of the container body 62 but won't be disengaged from container body 62 during centrifugation. An elastomeric seal component 64 is placed on the movable plunger rod 61 to ensure that fluid is sealed and sterilely contained in the centrifugation container 6. Fluid communication with exterior of the centrifugation container 6 is through a centrifugation container connector 63 with a luer lock feature 63b for connecting with the tubing 53.

The container body 62 is assembled with the centrifugation container connector 63 though an outward projected snap fit. This outward projected engagement allows the device securely placed in the a centrifugation chamber assembly (more details about design and function of the centrifugation chamber will be explained later) during centrifugation. There is a flat face feature 63a on the centrifugation container connector 63 to keep the container body 62 stationary while the movable plunger rod 61 is being rotated. There could be an optional an elastomeric seal ring placed between the centrifugation container connector 63 and container body 62. The seal is optional when the centrifugation container connector 63 is assembled together with the container body 62 through welding or gluing process. On the fluid contacting end of the movable plunger rod 61, there is a mixing blade 61a. When movable plunger rod 61 rotates, the mixing blade 61a can generate axial and/or radial mixing forces. The mixing blade design herein is for example only. Other blade designs, including different number of blades, different blade orientation, curved or pitched blades, used to create better mixing for cell suspension can be incorporated herein accordingly. On the other end of the movable plunger rod 61, there is a flat face feature 61c to enable rotational movement of the movable plunger rod 61.

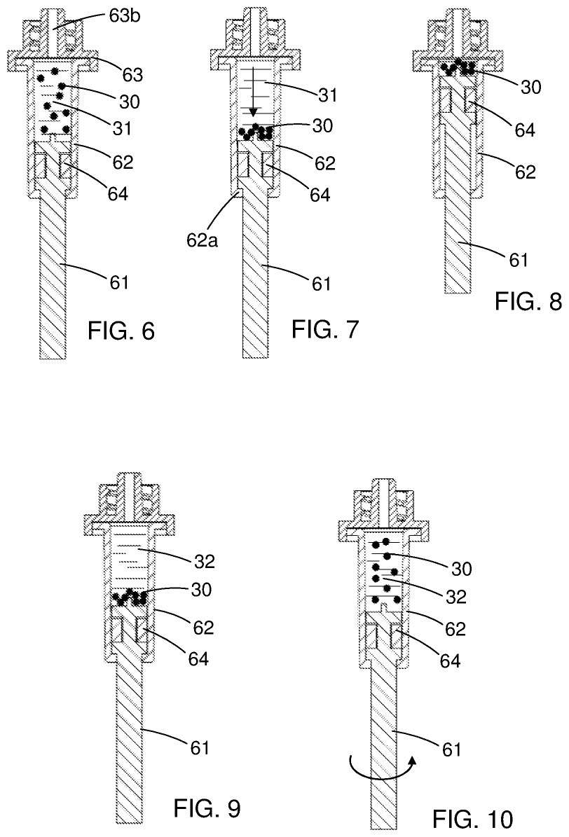

With reference to FIG. 6-10, during operation, the movable plunger rod 61 together with the elastomeric seal component 64 moves from the top end of the container body 62 to the bottom end of the container body 62 so that the cell suspension, containing cells 30 and cell culture media 31, can be withdrawn into the centrifugation container 6, as shown in FIG. 6. Then, centrifugation is started through a centrifugation equipment 700 (more details about design and function of the centrifugation equipment 700 will be explained later) to separate the cells 30 (into cell pellet form) and the cell culture media 31 by centrifugation force, as shown in FIG. 7 (the arrow in FIG. 7 indicates centrifugation direction). After the centrifugation, the movable plunger rod 61 together with the elastomeric seal component 64 moves from the bottom end of the container body 62 toward to the top end of the container body 62 so that the cell culture media 31 is expelled out from the container body 62 while keeping the cells inside the container body 62, as shown in FIG. 8. Then, with help of fluid control valves 5, cryopreservation media 32 is withdrawn into the container body 62 by moving the movable plunger rod 61 together with the elastomeric seal component 64 toward to the bottom end of the container body 62, as shown in FIG. 9. To re-suspend cells 30 into the cryopreservation media 32, the movable plunger rod 61 is rotated and the mixing blade 61a on the movable plunger rod 61 will create mixing force and break up the cell pellet for re-suspension, as shown in FIG. 10.

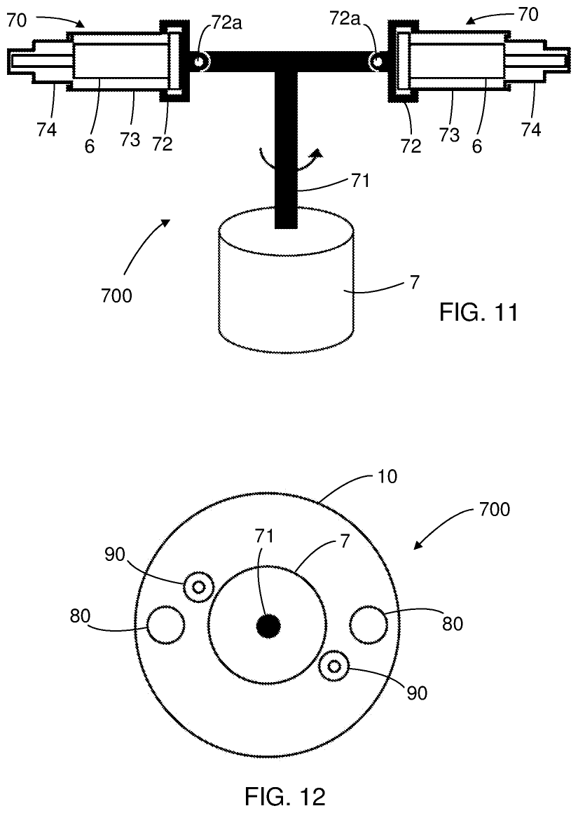

The centrifugation equipment 700 will now be described. The centrifugation equipment 700 is located in the console housing 10. For processes implemented by the system, The centrifugation equipment 700 have several components as well as the overall design approach in common. With reference to FIG. 11-15, the centrifugation equipment 700 consists of a main rotor 7, a centrifugation frame 71, and a centrifugation chamber assembly 70, as well as an axial movement motor assembly 80 and a rotational movement motor assembly 90. The centrifugation chamber assembly 70 is to host the centrifugation container 6. In use, the centrifugation container 6 is placed into the centrifugation chamber assembly 70, which includes a hinge connector 72, a chamber upper body 73 and a chamber lower body 74. The hinge connector 72 is linked to the centrifugation frame 71, which is installed on the main rotor 7, through a pivot 72a. There is a opening hole (not shown) on the hinge connector 72 to allow in the tubing 53 to pass through. There are also flat faces (not shown) in the interior wall of the hinge connector 72 to align with the flat face feature 63a on the centrifugation container connector 63 of the centrifugation container 6. The pivot hinge design allows the the centrifugation chamber 70 to be swung outward under centrifugation force (as shown in FIG. 11). While at resting, the centrifugation chamber 70 is hung vertically on the rotating frame 71. Furthermore, the pivot hinge design prevents the connecting hinge 72 and the chamber upper body 73 from rotating around the axial of the centrifugation chamber 70. Meantime, the chamber lower body 74 is connected with the chamber upper body 73 in a telescope manner. Therefore, the chamber lower body 74 is free to rotate, as well as free to move up and down, along the axial of the centrifugation chamber 70, while keeping the container body 62 stationary in the centrifugation chamber 70. The movable plunger rod 61 is placed in the chamber lower body 74 by, for example, snap fit connection. When the chamber lower body 74 moves up and down, the movable plunger rod 61 moves up and down accordingly. There is also flat face (not shown) in the interior wall of the chamber lower body 74 to align with the flat face feature 61c of the movable plunger rod 61. When the chamber lower body 74 rotates, the movable plunger rod 61 rotates accordingly. In summary, the chamber upper body 73 is stationary relative to the container body 62 and the lower body 74 is free to move relative to the container body 62.

During centrifugation, the main rotor 7 rotates to generate centrifugal field. The centrifugal field extends to the centrifugation container 6 radially through the centrifugation chamber 70. With sufficient centrifugal force provided in the centrifugal field, the cell suspension in the centrifugation container 6 will be separated into cell pellet layer and supernatant layer (as illustrated in the FIGS. 6 and 7).

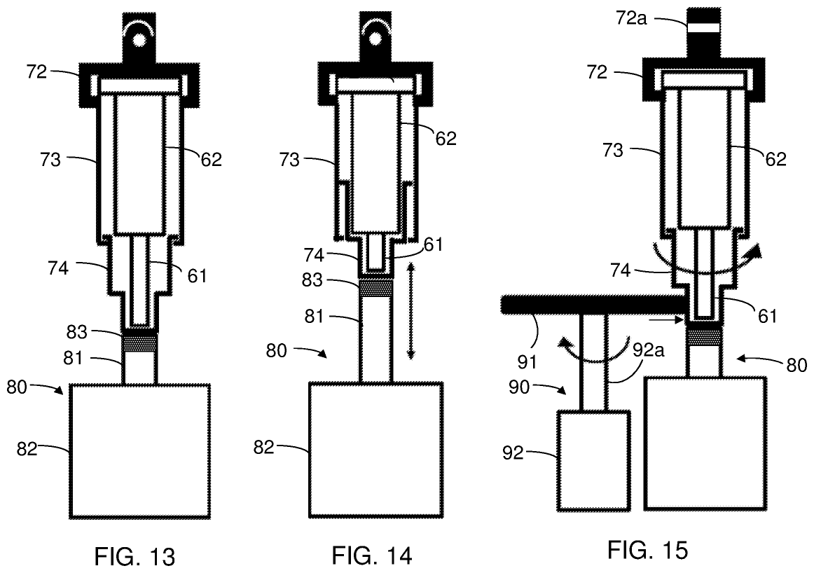

The centrifugation equipment 700 also include the axial movement motor assembly 80 and the rotational movement motor assembly 90. The axial movement motor assembly 80 is used for withdrawing fluid into the container body 62 and expelling fluid out of the container body 62. The rotational movement motor assembly 90 is used for re-suspending cells in the media. With reference to the console housing 10 and the main rotor 7, the relative locations of the axial movement motor assembly 80 and the rotational movement motor assembly 90 are exemplarily, during centrifugation process and fluid withdrawing/expelling process, illustrated in FIG. 12, as a top view. The location arrangement of the motor assemblies 80 and 90 is designed to avoid any interference to the centrifugation chamber 70 during centrifugation process. FIGS. 13 to 15 describes the operations of the axial movement motor assembly 80 and the rotational movement motor assembly 90.

Shown conceptually in FIGS. 13 and 14, the axial movement motor assembly 80 is used for withdrawing fluid into the container body 62 and expelling fluid out of the container body 62 during the media exchange process for cell therapy product manufacturing. The axial movement motor assembly 80 may be a linear actuator with motor control. The component 81 is the position rod of the linear actuator. The position rod 81 can move up and down, but not rotatable. The housing 82 is the housing of the axial movement motor assembly 80. Inside the housing 82, there are typical linear actuator components, such as spindle, gear and motor. The circuit for rod position and stroke speed controls can be integrated in the housing 82 or placed outside of the housing 82. Various designs of linear actuators with control mechanisms are well known in the art. Persons of ordinary skill in the art will appreciate that other design alternatives are possible. The connection between the position rod 81 and the chamber lower body 74 can be formed by a magnetic interaction. For example, the lower body 74 can be made of magnetic metals, such as iron, nickel, cobalt or alloys. On the top of position rod 81, an electromagnet 83 may be installed. During centrifugation process, the electromagnet 83 is turned off. Therefore, the centrifugation chamber assembly 70 and the centrifugation container 6 can be spun as as illustrated in FIG. 11. During withdrawing fluid into the container body 62 and expelling fluid out of the container body 62, the electromagnet 83 is turned on. Consequently, the position rod 81 and the chamber lower body 74 are connected by magnetic force. At the same time, the movable plunger rod 61 is connected with the position rod 81, as well. During withdrawing fluid into the container body 62, the position rod 81 moves downward and the lower body 74 together with the movable plunger rod 61 moves downward accordingly to draw fluid into the container body 62. The volume of fluid drawn into the container body 62 can be controlled by controlling the distance of downward movement of the lower body 74 through the control mechanism in the linear actuator. During expelling fluid out of the container body 62, the position rod 81 moves upward and the movable plunger rod 61 moves upward accordingly to expel fluid out of the container body 62. The volume of fluid expelled out of the container body 62 can be controlled by controlling the distance of upward movement of the lower body 74 through the control mechanism in the linear actuator and optional cell sensing component in the fluid path, such as optical sensor for cell. When the sensing component is used, the upward movement of the position rod 81 can be stopped if the sensing component detects cell in the tubing 53. By this control, accidental loss of cells can be avoided when the fluid is expelled out of the container body 62.

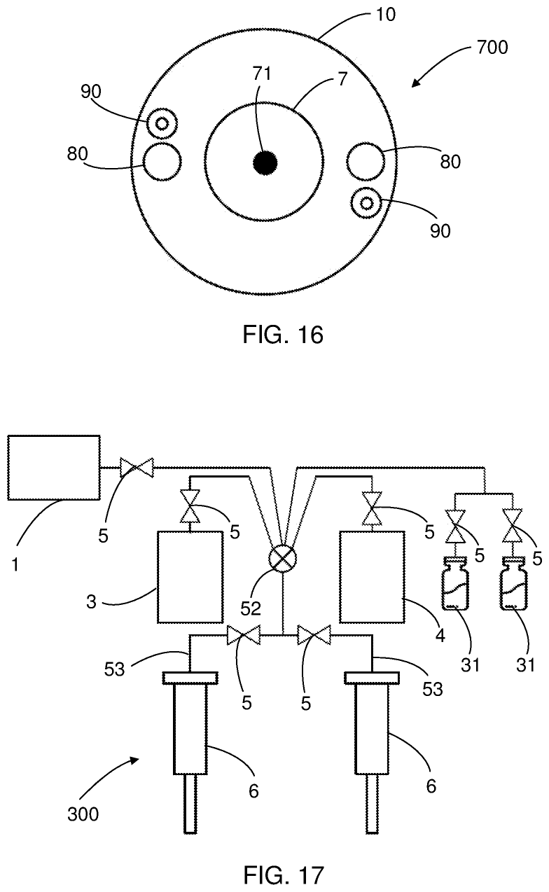

Shown conceptually in FIG. 15, rather than withdrawing fluid into the container body 62 and expelling fluid out of the container body 62, the rotational movement motor assembly 90 is used for re-suspending cells in the liquid media during the re-suspension process for cell therapy product manufacturing. The rotational movement motor assembly 90 may include a rotation motor 92 with a shaft 92a. A rubber wheel 91 may be installed on the top of the shaft 92a. The rotational movement motor assembly 90 may be installed on a sliding rack inside the housing 10. The location of the rotational movement motor assembly 90 can be changed according to process needs. Persons of ordinary skill in the art will appreciate that other design alternatives are possible for the location control for the rotational movement motor assembly 90. During cell re-suspension, the rotational movement motor assembly 90 is moved from the location illustrated in FIG. 12 to the location illustrated in FIG. 16. With reference to FIG. 15, the rubber wheel 91 will apply some pushing force on the chamber lower body 74 at the new location illustrated in FIG. 16. The direction of the pushing force is toward to the right, indicated by an horizontal arrow under the rubber wheel 91 in FIG. 15. The direction of the push force is parallel to the axial of the pivot 72a. Therefore, the chamber lower body 74 can't move toward to the right under the pushing force. Consequently, there will be friction between the rubber wheel 91 and the chamber lower body 74 when the rubber wheel 91 rotating. Because of the friction between the rubber wheel 91 and the chamber lower body 74, the chamber lower body 74 rotates when the rubber wheel 91 is rotated by the rotation motor 92 (as indicated in FIG. 15). The rotation of the chamber lower body 74 will cause the movable plunger rod 61 rotate accordingly. When the movable plunger rod 61 rotates, the mixing blade 61a will rotate to generate mixing forces to re-suspend cells into liquid media (as shown in FIGS. 9 and 10). There may be control mechanism in the rotational movement motor assembly 90 to control the direction (clockwise vs counter-clockwise) or speed of the rotation of the rubber wheel 91.

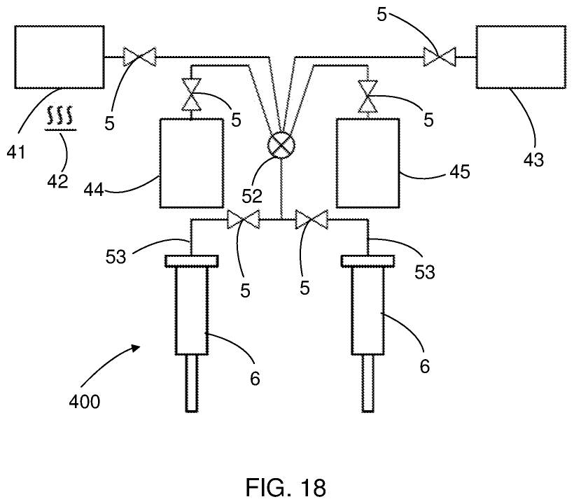

FIGS. 17 and 18 are schematic views of alternative designs of the disposable set 200. A conceptual design of a disposable set 300 is shown in FIG. 17. The disposable set 300 may be also used for media exchange for preparing cell suspension for cryopreservation. In the disposable set 300, rather than using a single container component to contain cell suspension in cryopreservation media, multiple containers 31 are used to contain cell suspension in cryopreservation media. The multiple containers 31 can be vials, syringes, bottles, bags or mixed types. Using multiple containers 31 can enable more dose options and analytical sample options. A conceptual design of another disposable set 400 is shown in FIG. 18. The disposable set 400 may be used for media exchange for preparing cell suspension for final product infusion. In the disposable set 400, container component 41 is to contain cell suspension in cryopreservation media. A heating accessory 42 can be placed adjacent to the container component 41 to control the thawing process for the frozen cell suspension content in the container component 41. Container component 43 is to contain cell suspension for final product infusion. Container component 44 is to contain waste and container component 45 is to contain fresh infusion media. The operation of the apparatus herein using different types of the disposable sets of this invention is substantially as the same as the operation of the apparatus using disposable set 200.

All processes within the system are controlled by electronic controls (not shown) contained within the console 100 in a conventional manner utilizing a microprocessor-based controller with an optional watchdog microprocessor, or multiple microprocessors, that meet medical device electronic system requirements. Electronic PC boards or similar structures provide electronic interfaces to various motors, actuators, and sensors. Although not shown, it will be understood that all operations of components are controlled and/or monitored by the microprocessor or other controller utilizing standard techniques known in the art, in response to inputs from the sensors, such as the pressure transducers, optical sensors, air bubble detectors, temperature sensors and to set process procedures programmed into software, stored in a ROM or other storage device, which is used to implement the process. It will be understood that all components will be electronically coupled to such controller via control circuits such as printed circuit board. Control software to control the microprocessor may be written in C or another suitable programming language, and should follow FDA and ISO guidelines for medical device software.

All the features in the above embodiments and design concepts herein can be inter-changed and combined to generate new system designs. Those of skill in the art will understand that modifications (additions and/or removals) of various components of the apparatuses, methods and/or systems and embodiments described herein may be made without departing from the full scope and spirit of the present invention, which encompass such modifications and any and all equivalents thereof.

1. A system for processing a cell therapy product, comprising:
a centrifugation container comprising a substantially cylindrically shaped container body and a movable plunger rod, wherein the container body contains cell suspension and the movable plunger rod is configured to have a mixing blade at the end of the movable plunger rod contacting the cell suspension in the container body, wherein the mixing blade generates mixing force applied to the cell suspension when the movable plunger rod is rotated around axis of the container body; and
a rotor generating centrifugal field that extends to the centrifugation container.

2. The system of claim 1, wherein the end of the movable plunger rod contacting the cell suspension is movable in the container body along longitudinal direction of the container body.

3. The system of claim 2, wherein the cell suspension is kept sterile in the centrifugation container.

4. The system of claim 2, further comprising a centrifugation chamber assembly, having an upper body and a lower body, to host the centrifugation container, wherein the upper body is stationary relative to the container body and the lower body is free to move relative to the container body.

5. The system of claim 4, further comprising a linear actuator to move the lower body of the centrifugation chamber assembly along the longitudinal direction of the container body.

6. The system of claim 5, further comprising a control mechanism to control the distance of movement of the lower body of the centrifugation chamber assembly.

7. The system of claim 4, further comprising a rotation motor to rotate the lower body of the centrifugation chamber assembly around the axis of the container body.

8. The system of claim 7, further comprising a control mechanism to control the rotational movement of the lower body of the centrifugation chamber assembly.

9. The system of claim 1, further comprising a container component to contain cell suspension, wherein the container component is bag, bottle, vial or syringe.

10. The system of claim 9, wherein cell suspension in the container component is in plasma, culture media, washing media, cryopreservation media or infusion media.

11. The system of claim 9, further comprising a temperature control adjacent to the container component.

12. A method of changing media in cell suspension, comprising:
providing a centrifugation container having a substantially cylindrically shaped container body and a movable plunger rod, wherein the container body contains cell suspension and the movable plunger rod is configured to have a mixing blade at the end of the movable plunger rod contacting the cell suspension in the container body, wherein the mixing blade generates mixing force applied to the cell suspension when the movable plunger rod is rotated around axis of the container body;
withdrawing cell suspension in a first liquid media into the centrifugation container by moving the movable plunger rod along longitudinal direction of the container body;
generating centrifugal field that extends to the centrifugation container to separate cells and the first liquid media;
expelling the first liquid media out of the centrifugation container by moving the movable plunger rod along the longitudinal direction of the container body;
withdrawing a second liquid media into the centrifugation container by moving the movable plunger rod along the longitudinal direction of the container body; and
re-suspending cells in the second liquid media by rotating the movable plunger rod around the axis of the container body.
